(19) United States
(12) Patent Application Publication
(10) Pub. No.: US 2015/0378167 A1
(43) Pub. Date: Dec. 31, 2015

(54) THREE-DIMENSIONAL DISPLAY DEVICE

(71) Applicant: Japan Display Inc., Tokyo (JP)

(72) Inventors: Shinichiro OKA, Tokyo (JP); Yingbao Yang, Tokyo (JP); Takeo Koito, Tokyo (JP)

(21) Appl. No.: 14/755,318

(22) Filed: Jun. 30, 2015

(30) Foreign Application Priority Data
Jun. 30, 2014 (JP) 2014/134211

(51) Int. Cl. G02B 27/22; G02F 1/1343

(52) U.S. Cl. CPC G02B 27/2214; G02F 1/134363; G02F 2001/134345

(57) ABSTRACT

Provided is a three-dimensional image display device which allows a favorable three-dimensional image to be recognized without generating flicker even under a movement of the line of sight. A liquid crystal parallax barrier panel is arranged on a display panel. The liquid crystal parallax barrier panel includes a barrier substrate having barrier electrodes formed thereon, a common substrate provided with a common electrode, and liquid crystal held between the barrier substrate and the common electrode. Barriers are formed by applying a voltage to the barrier electrodes. Where τon represents a time required to form barriers on the barrier electrodes after a voltage is applied to the barrier electrodes and τoff represents a time required to cancel the barriers after the voltage is removed from the barrier electrodes, a value of (τoff−τon) is 15 milliseconds or less, preferably 10 milliseconds or less.

### CLAIM OF PRIORITY

The present application claims priority from Japanese Patent Application JP 2014-134211 filed on Jun. 30, 2014, the content of which is hereby incorporated by reference into this application.

### BACKGROUND OF THE INVENTION

1. Field of the Invention

The present invention relates to a display device and more particularly to a three-dimensional image display device using a liquid crystal parallax barrier panel.

2. Description of the Related Art

As a method for displaying a three-dimensional image without using glasses, a parallax barrier scheme is known. The parallax barrier scheme is a method in which a plate, called a parallax barrier panel, having multiple thin slits extending in the vertical direction is prepared. An image to be seen by the right eye and that by the left eye are each cut into a vertically-long, strip-shaped rectangle. Then, the cut images for both eyes are alternately arranged at the back of the parallax barrier panel. The images are thereby displayed as a three-dimensional image through the parallax barrier. The liquid crystal parallax barrier panel that includes liquid crystal can easily switch its display mode between two-dimensional display and three-dimensional display.

The parallax barrier scheme has a problem that the luminance of the screen varies with eye movement. To suppress the variation in the screen luminance, JPA-2013-195955 describes a configuration for changing the waveform of a voltage to be applied to barrier electrodes.

### SUMMARY OF THE INVENTION

The parallax barrier scheme has a problem that crosstalk occurs upon a movement of a viewpoint. The crosstalk is a phenomenon in which a pixel that should be seen by only the left eye is seen by the right eye, for example. To prevent this, there is a scheme in which a camera tracks the positions of the eyes and the position of a barrier is controlled according to the positions of the eyes so that crosstalk is suppressed. This scheme is called an eye tracking scheme.

In this scheme, in which the position of a barrier is controlled according to the positions of the eyes, however, it has been found that the response speed of the barriers plays a very important role for achieving favorable three-dimensional display. Specifically, to change the positions of the barriers, one barrier is turned on while another barrier is turned off. In this case, if the speed at which the barrier is turned on is different from the speed at which the other barrier is turned off, flicker is recognized. JP-A-2013-195955 describes a configuration for changing an ON waveform and an OFF waveform for matching the speed of turning on the barrier with the speed of turning off the barrier. This method, however, requires an additional waveform generating circuit for changing the ON waveform and the OFF waveform, which increases the total cost.

An object of the invention is to achieve, at low cost, a three-dimensional image display device that suppresses the occurrence of flicker caused by switching of barriers in a parallax barrier scheme using eye tracking.

The invention has been made to solve the aforementioned problems, and specific details are described below.

(1) A three-dimensional display device includes: a display panel; and a liquid crystal parallax barrier panel arranged on the display panel, the liquid crystal parallax barrier panel changing position of its barriers in accordance with a change in positions of viewer's eyes. The display panel includes pixels arranged at first pitches in a first direction, the pixels each having a first sub-pixel, a second sub-pixel, and a third sub-pixel which are arranged in the first direction. The liquid crystal parallax barrier panel includes a barrier substrate, a common substrate, and liquid crystal held between the barrier substrate and the common substrate. On the barrier substrate, the barriers extend in a second direction perpendicular to the first direction and are arranged at second pitches in the first direction. The barriers of the liquid crystal parallax barrier panel include barrier electrodes extending in the second direction and arranged in the first direction at third pitches. The barriers are formed by applying a barrier signal to the barrier electrodes. Where τon represents a time required to form barriers on the barrier electrodes after a voltage is applied to the barrier electrodes and τoff represents a time required to cancel the barriers after the voltage is removed from the barrier electrodes, a value of (τoff−τon) is 15 milliseconds or less.

(2) In the three-dimensional display device described in (1), the value of (τoff−τon) is 10 milliseconds or less.

(3) A three-dimensional display device includes: a display panel; and a liquid crystal parallax barrier panel arranged on the display panel, the liquid crystal parallax barrier panel changing position of its barriers in accordance with a change in positions of viewer's eyes. The display panel includes pixels arranged at first pitches in a first direction, the pixels each having a first sub-pixel, a second sub-pixel, and a third sub-pixel which are arranged in the first direction. The liquid crystal parallax barrier panel includes a barrier substrate, a common substrate, and liquid crystal held between the barrier substrate and the common substrate. On the barrier substrate, the barriers extend in a second direction perpendicular to the first direction and are arranged at second pitches in the first direction. The barriers of the liquid crystal parallax barrier panel include barrier electrodes extending in the second direction and arranged in the first direction at third pitches. The liquid crystal parallax barrier panel satisfies a relationship of (γ≦(0.015π²K)/d²), where γ is a viscosity coefficient of liquid crystal and is expressed in a unit of Pascal×seconds, 0.015 is expressed in second, K is the average of an elastic constant K11 for splay deformation, an elastic constant K22 for twist, and an elastic constant K33 for bending or is (K11+K22+K33)/3 and expressed in Newton, and d is the thickness of a liquid crystal layer and expressed in meter.

(4) In the three-dimensional display device described in (3), the liquid crystal parallax barrier panel satisfies a relationship of (γ≦(0.01π²K)/d²), where 0.01 is expressed in second.

(5) In the three-dimensional display device described in (3) or (4), when a refractive index anisotropy of the parallax barriers is Δn, 400 nm≦Δn·d≦560 nm is satisfied.

(6) A three-dimensional display device includes: a display panel; and a liquid crystal parallax barrier panel arranged on the display panel, the liquid crystal parallax barrier panel changing position of its barriers in accordance with a change in positions of viewer's eyes. The display panel includes pixels arranged at first pitches in a first direction, the pixels each having a first sub-pixel, a second sub-pixel, and a third sub-pixel which are arranged in the first direction. The liquid crystal parallax barrier panel includes a barrier substrate, a common substrate, and liquid crystal held between the barrier substrate and the common substrate. On the barrier substrate, the barriers extend in a second direction perpendicular to the first direction and are arranged at second pitches in the first direction. The barriers of the liquid crystal parallax barrier panel include barrier electrodes extending in the second direction and arranged in the first direction at third pitches. The barriers are formed by applying a barrier signal to the barrier electrodes. Where a dielectric anisotropy of the liquid crystal is Δε and a voltage applied to the barrier electrodes is V, 16≦Δε·V≦40 is satisfied.

(7) In the three-dimensional display device described in (6), 22≦Δε·V≦27 is satisfied.

According to the invention, in a three-dimensional image display device using a liquid crystal parallax barrier panel, even when the positions of barriers are changed in accordance with a movement of a viewpoint, the difference between a time required to turn on a barrier electrode and a time required to turn off a barrier electrode can be reduced, and a favorable three-dimensional image can be recognized without using a special voltage waveform generating circuit.

### BRIEF DESCRIPTION OF THE DRAWINGS

FIG. 1 is a cross-sectional schematic diagram of a three-dimensional image display device according to the invention.

FIG. 2 is a cross-sectional schematic diagram describing a principle of a parallax barrier scheme.

FIG. 3A is a cross-sectional diagram of a liquid crystal parallax barrier panel when a barrier is not formed.

FIG. 3B is a cross-sectional diagram of the liquid crystal parallax barrier panel when a barrier is formed.

FIG. 4 is a cross-sectional diagram of the liquid crystal parallax barrier panel.

FIG. 5 is a cross-sectional view of another liquid crystal parallax barrier panel.

FIG. 6 is a cross-sectional view of still another liquid crystal parallax barrier panel.

FIG. 7 is a schematic diagram illustrating an eye tracking system.

FIG. 8 is a graph showing a time required to turn on a barrier electrode and a time required to turn off a barrier electrode in the liquid crystal parallax barrier panel.

FIG. 9 is a graph showing the difference between the time required to turn on a barrier electrode and the time required to turn off a barrier electrode and the level of a change in luminance on a screen.

FIG. 10 is a graph showing a relationship between retardation of the liquid crystal parallax barrier panel and a transmittance.

FIG. 11 is a graph showing a relationship between a value of (Δε·V) of the liquid crystal parallax barrier panel and the time τon required to turn on a barrier electrode.

FIG. 12 is a graph showing relationships between the value of (Δε·V) of the liquid crystal parallax barrier panel and contrast.

FIG. 13 is a table showing parameters used for simulation described with reference to FIG. 12.

### DESCRIPTION OF THE PREFERRED EMBODIMENTS

Hereinafter, the invention is described using an embodiment.

### First Embodiment

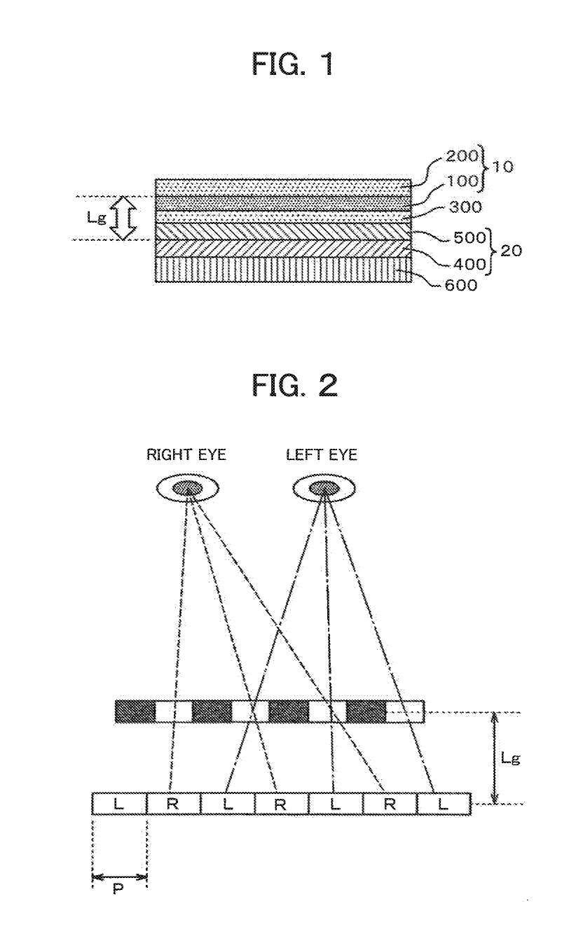

FIG. 1 is a cross-sectional schematic diagram of a three-dimensional image device according to the invention. The device illustrated in FIG. 1 uses a liquid crystal parallax barrier panel 10 to enable an image formed by a liquid crystal display panel 20 to be visually recognized as a three-dimensional image. The liquid crystal parallax barrier panel 10 and the liquid crystal display panel 20 are bonded to each other by a bonding member 300. A transparent bonding member such as acrylic resin is used as the bonding member 300.

In FIG. 1, the liquid crystal panel 20 is used, but may be replaced with an organic electroluminescence display device (organic light-emitting diode; OLED) or the like. In addition, the liquid crystal display panel may be of any of an IPS type, a VA type, a TN type, and the like. The IPS type is superior in terms of a viewing angle characteristic and suitable for three-dimensional image display of a parallax barrier scheme. In FIG. 1, a distance between the center of a liquid crystal layer of the liquid crystal display panel 20 and the center of a liquid crystal layer of the liquid crystal parallax barrier panel 10 is Lg.

The liquid crystal display panel 20 has a configuration in which liquid crystal is sandwiched and held between a TFT substrate 400 and an opposing substrate 500, while the TFT substrate 400 has pixels provided with TFTs and pixel electrodes and formed in a matrix. The liquid crystal parallax barrier panel 10 has a configuration in which liquid crystal is sandwiched and held between a barrier substrate 100 having barrier electrodes 110 formed therein and a common substrate 200 having a common electrode 210 formed therein. Although not illustrated in FIG. 1, a lower polarizing plate is arranged under the liquid crystal display panel 20, a middle polarizing plate is arranged on the top of the liquid crystal display panel 20, and an upper polarizing plate is arranged on the top of the liquid crystal parallax barrier panel 10.

Since the liquid crystal display device itself does not emit light, a backlight 600 is arranged on a back surface of the liquid crystal display panel. The backlight 600 includes a light source, a light guide plate, and a diffuser plate and may include an optical part such as a prism sheet for improving a light use efficiency.

FIG. 2 is a cross-sectional diagram describing a principle of three-dimensional image display of the parallax barrier scheme. Due to a barrier region and an opening region that are formed in the liquid crystal parallax barrier panel, the right eye recognizes only a pixel R formed for the right eye in the display device, the left eye recognizes only a pixel L formed for the left eye in the display device, and thus a person can recognize a three-dimensional image. Each of the pixels R and L in FIG. 2 has a first sub-pixel, second sub-pixel, and third sub-pixel, which are arranged in the lateral direction of FIG. 2.

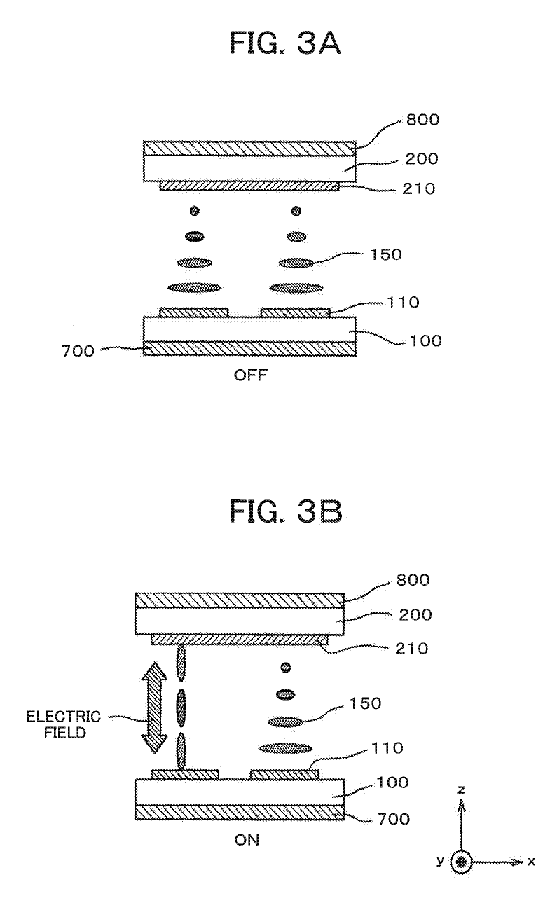

FIGS. 3A and 3B are cross-sectional diagrams describing operations of the liquid crystal parallax barrier panel. The liquid crystal parallax barrier panel illustrated in FIGS. 3A and 3B is of a normally-white TN type in which light passes through the panel when a signal is not applied. Although the liquid crystal parallax barrier panel may be of a normally-black TN type, a transmittance of the normally-white TN type is larger than a transmittance of the normally-black TN type. Thus, the normally-white TN type is suitable for the liquid crystal parallax barrier panel. Although the TN type is described as the liquid crystal parallax barrier panel in this specification, a liquid crystal panel of another operational type may be used as long as a barrier pattern can be formed.

FIG. 3A illustrates a case where a signal is not applied to the barrier electrodes 110. In FIG. 3A, on the barrier substrate 100, the barrier electrodes 110 extend in a direction perpendicular to the sheet of FIG. 3A and are each formed in a stripe shape. A common electrode 210 is formed in a plate-like shape on the common substrate 200. A middle polarizing plate 700 is arranged under the barrier substrate 100, while an upper polarizing plate 800 is arranged on the common substrate 200. The middle polarizing plate 700 serves as a lower polarizing plate for a normal liquid crystal display.

In the case illustrated in FIG. 3A, light emitted from the liquid crystal display panel is not modulated by the liquid crystal parallax barrier panel. Thus, an image displayed on the liquid crystal display panel is recognized as a two-dimensional image. FIG. 3B illustrates a case where a signal is applied to the barrier electrodes 110 and a barrier pattern is formed. A configuration illustrated in FIG. 3B is the same as described with reference to FIG. 3A. In a liquid crystal layer located in a space in which the signal is applied to the barrier electrodes 110, liquid crystal molecules are vertically oriented so as to lose an optical rotation property and block light transmitted from the backlight. In this manner, the position of the barrier pattern can be controlled by applying a voltage to the barrier electrodes 110.

A problem with the parallax barrier scheme is that when the positions of the eyes change, angles at which the left eye or the right eye sees pixels change and pixels to be visually recognized by only the right eye can be visually recognized by the left eye or so-called crosstalk occurs, for example. To take measures against the crosstalk, the positions of barriers are changed in accordance with the movements of the eyes. To perform this operation, first of all, it is necessary to recognize the positions of the eyes. This is referred to as eye tracking.

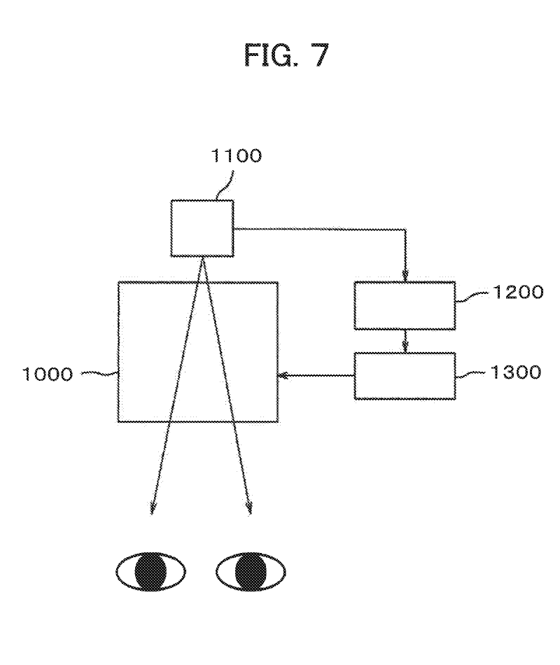

FIG. 7 is a diagram showing a configuration for eye tracking. In FIG. 7, a camera 1100 measures the positions of the eyes of a person and transfers data of the measured positions to a position detector 1200. The position detector 1200 generates data representing the positions of the eyes and transfers the generated data to a barrier controller 1300. The barrier controller 1300 generates a signal for the barrier electrodes in order to form the barriers, transmits the signal to a three-dimensional display device 1000 having the liquid crystal parallax barrier panel, and causes the three-dimensional display device 1000 to achieve three-dimensional display based on changes in the positions of the eyes.

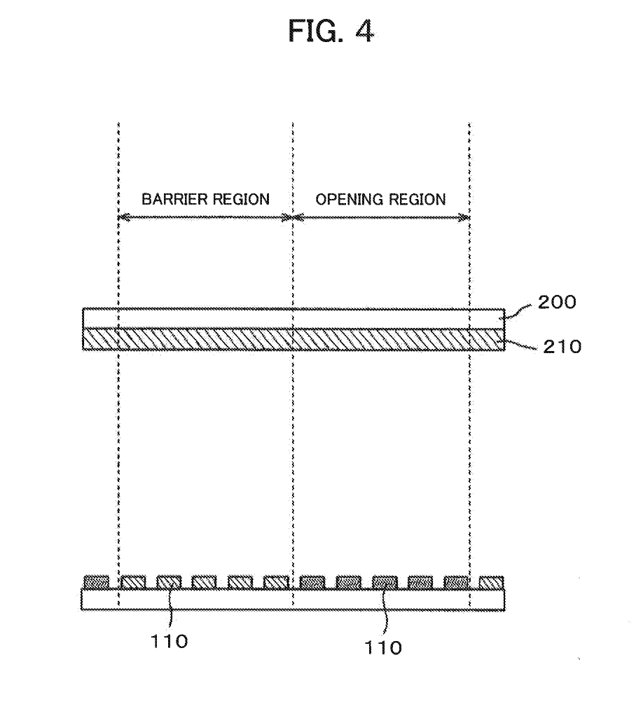

FIG. 4 is a cross-sectional diagram showing the liquid crystal parallax barrier panel included in the three-dimensional display device. In FIG. 4, a voltage is applied to barrier electrodes 110 illustrated by hatching, and light is not transmitted through the barrier electrodes 110 illustrated by hatching. Thus, the barrier electrodes 110 illustrated by hatching form a barrier region. A voltage is not applied to barrier electrodes 110 illustrated by dots, and light is transmitted through the barrier electrodes 110 illustrated by the dots. Thus, the barrier electrodes 110 illustrated by the dots form an opening region. In FIG. 4, the barrier region is formed by the five barrier electrodes 110, and the opening region is formed by the five barrier electrodes 110. In FIG. 4, the common substrate 200 provided with the common electrode 210 is arranged opposite to the barrier substrate 100 so that the liquid crystal layer is held between the common substrate 200 and the barrier substrate 100. The common electrode 210 is formed in a plate-like shape on the common substrate 200 and common to the barrier electrodes.

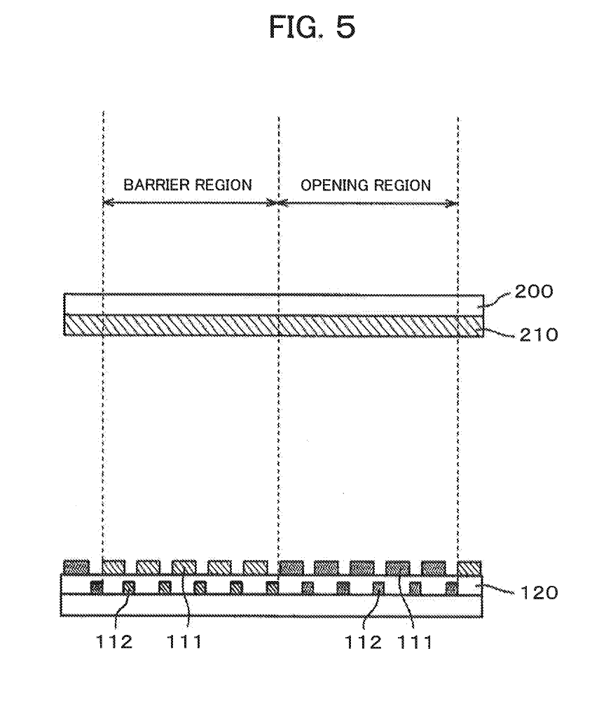

FIG. 5 is a cross-sectional diagram showing another liquid crystal parallax barrier panel for the three-dimensional display device. In FIG. 5, a barrier region is formed by five first barrier electrodes 111, and an opening region is formed by five first barrier electrodes 111. Gaps between the first barrier electrodes 111 are filled by second barrier electrodes 112 as seen in a plan view. The second barrier electrodes 112 are provided to prevent pixel information from leaking from the gaps between the first barrier electrodes 111 and prevent the occurrence of crosstalk.

In FIG. 5, a voltage is applied to the first barrier electrodes 111 illustrated by hatching and second barrier electrodes 112 illustrated by hatching, and light is not transmitted through the first barrier electrodes 111 illustrated by hatching and the second barrier electrodes 112 illustrated by hatching. Thus, the first barrier electrodes 111 illustrated by hatching and the second barrier electrodes 112 illustrated by hatching form the barrier region. A voltage is not applied to the first barrier electrodes 111 illustrated by dots and second barrier electrodes 112 illustrated by dots, and light is transmitted through the first barrier electrodes 111 illustrated by the dots and second barrier electrodes 112 illustrated by the dots. Thus, the first barrier electrodes 111 illustrated by the dots and second barrier electrodes 112 illustrated by the dots form the opening region. In FIG. 5, the common substrate 200 provided with the common electrode 210 is arranged opposite to the barrier substrate 100 so that the liquid crystal layer is held between the common substrate 200 and the barrier substrate 100. The common electrode 210 is formed in a plate-like shape on the common substrate 200 and common to the barrier electrodes in the same manner as FIG. 4.

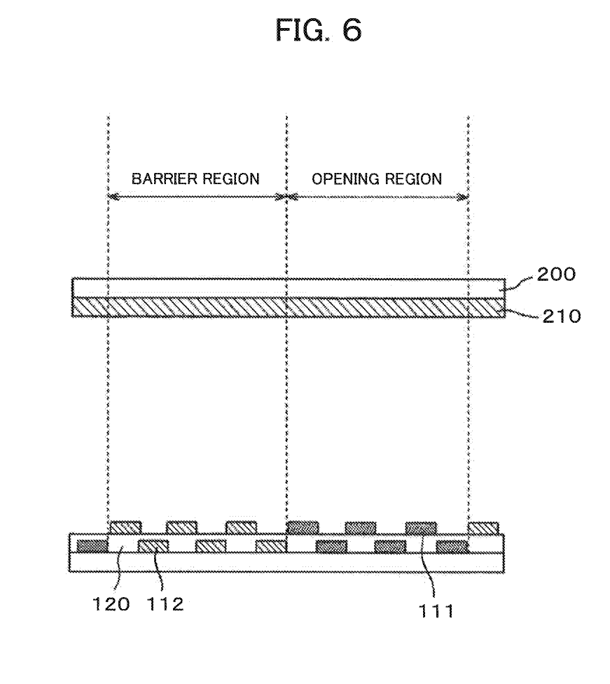

FIG. 6 is a cross-sectional diagram of another liquid crystal parallax barrier panel in which the widths of the first barrier electrodes 111 are equal to the widths of the second barrier electrodes 112. In FIG. 5, voltages of the second barrier electrodes having a small width change based on voltages of the first barrier electrodes 111. In a configuration illustrated in FIG. 6, voltages of the first barrier electrodes 111 and voltages of the second barrier electrodes 112 independently change. Other configurations illustrated in FIG. 6 are the same as or similar to FIG. 4 or 5.

If the positions of the barriers are changed in accordance with the positions of the eyes, and responses of the barriers are slow, a favorable three-dimensional image cannot be formed. In addition, if there is the difference between a time required to turn on a barrier electrode and a time required to turn off a barrier electrode, a favorable image cannot be formed. This is recognized as flicker.

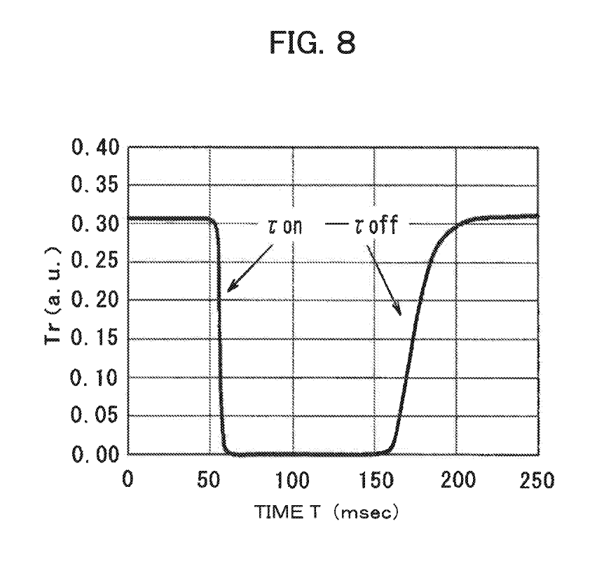

FIG. 8 is a diagram showing the time required to turn on a barrier electrode and the time required to turn off a barrier electrode in the liquid crystal parallax barrier panel. In FIG. 8, the ordinate represents a transmittance in arbitrary unit. When a barrier electrode is turned on, a barrier is formed and light is not transmitted through the barrier electrode. When a barrier electrode is turned off, light is transmitted through the barrier electrode. As shown in FIG. 8, a time τoff required to turn off a barrier electrode is longer than a time τon required to turn on a barrier electrode in general. In such a case, light is temporarily transmitted through two barrier regions. This effect is recognized as flicker and deteriorates an image.

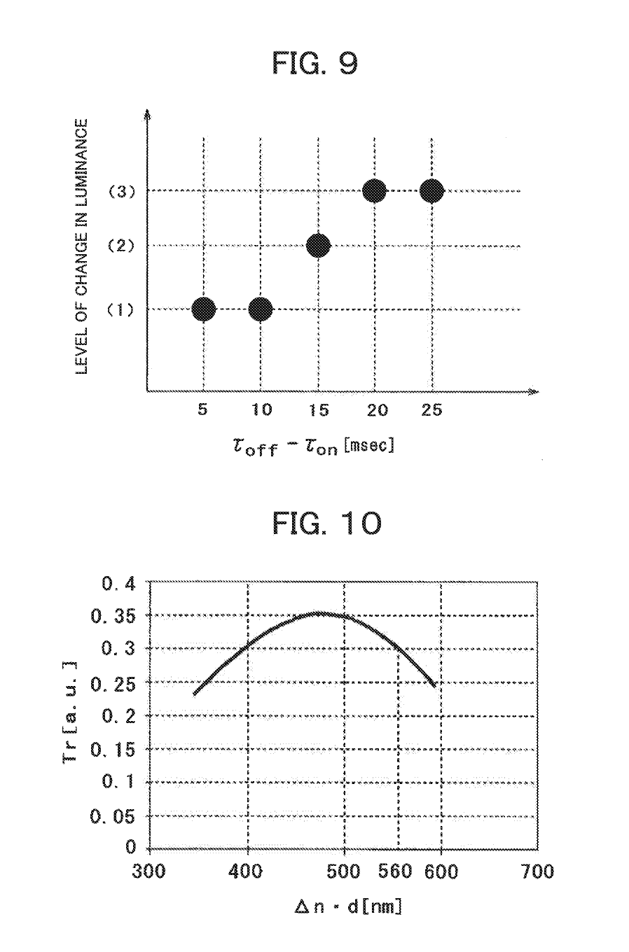

FIG. 9 is a graph showing the difference (τoff−τon) between the time required to turn off a barrier electrode and the time required to turn on a barrier electrode and the level of a change in luminance. On the ordinate of FIG. 9, (1) represents a level at which a change in luminance cannot be seen, (2) represents a level at which a change in luminance can be seen but is ignorable, and (3) represents a level at which a change in luminance can be seen. The level represented by (2) and lower are acceptable. As shown in FIG. 9, if the difference (τoff−τon) is equal to or lower than 15 milliseconds, a change in luminance can be seen but is ignorable. If the difference (τoff 31 τon) is equal to or lower than 10 milliseconds, a change in luminance is not recognizable.

A time τoff required to turn off TN liquid crystal included in the liquid crystal parallax barrier panel and a time τon required to turn on the TN liquid crystal can be expressed by the following equations:

τoff=(γd²)/(π²K) (1)

τon=γ/ε₀Δε(E²−(π²K)/d) (2)

where γ is a rotational viscosity coefficient of the liquid crystal, d is the thickness of the liquid crystal layer, K is an average elasticity coefficient, ε₀ is a permittivity of vacuum, Δε is a dielectric constant anisotropy of the liquid crystal, and E is an electric field applied to the liquid crystal. K is the average of an elastic constant K11 for splay deformation), an elastic constant K22 for twist, and an elastic constant K33 for bending or is (K11+K22+K33)/3. Regarding units, where the times τoff and τon are expressed in second, γ is expressed in a unit of Pascal (Pa)×seconds, d is expressed in meter, and K is expressed in Newton (N).

If the time τoff is 15 seconds or less, preferably 10 seconds, the difference (τoff−τon) between the time required to turn off a barrier electrode and the time required to turn on a barrier electrode can be set to a value of 15 seconds or less, preferably to a value of 10 seconds or less. To reduce the time τoff, it is sufficient if the viscosity coefficient γ of the liquid crystal is reduced. A value of the reduction in the viscosity coefficient γ of the liquid crystal can be obtained by transforming Equations (1) and (2).

To set the time τoff to 15 seconds or less, it is sufficient if γ≦(0.015π²K)/d². (3)

To set the time τoff to 10 seconds or less, it is sufficient if γ≦(0.01π²K)/d². (4)

According to Equations (1) and (2), the time τoff can be reduced by reducing the thickness d of the liquid crystal layer. However, there is a constraint for the thickness d in order to secure the transmittance of the liquid crystal layer. FIG. 10 is a graph showing a relationship between a value of Δnd of the TN liquid crystal and the transmittance Tr of the liquid crystal. In FIG. 10, the abscissa represents Δnd (nm), and the ordinate represents the transmittance Tr in arbitrary unit. To make the transmittance Tr be 0.3 or higher, the Δnd needs to be set as 400 nm≦Δnd≦560 nm.

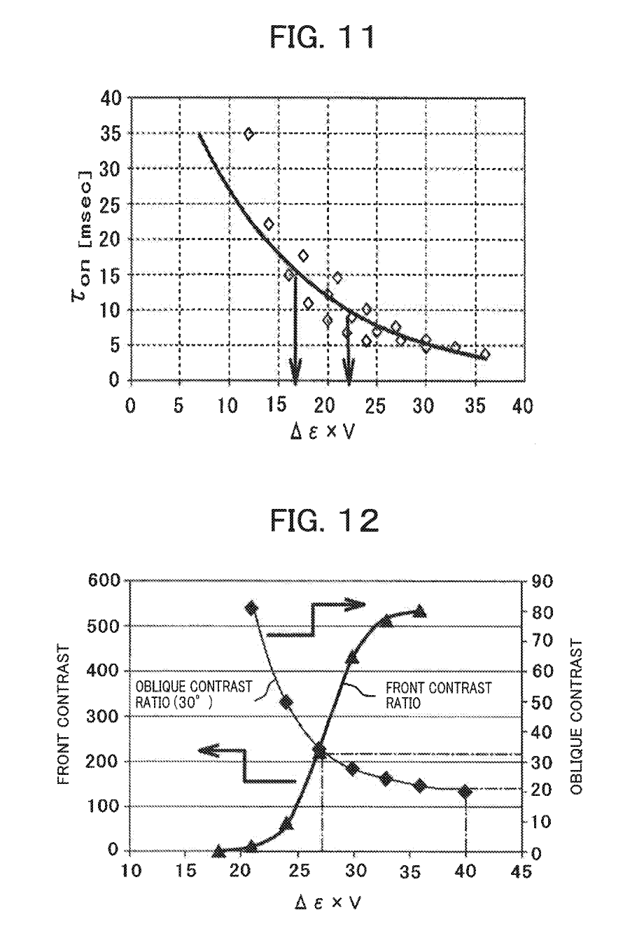

The time τoff required to turn off a barrier electrode may be reduced by reducing the time τon required to turn on a barrier electrode. Specifically, the occurrence of flicker can be prevented by reducing the both times τoff and τon. The time τon can be expressed by Equation (2). FIG. 11 is a graph showing a relationship between the time τon required to turn on a barrier electrode and a product Δε·V (V) of a voltage V (V) applied to the liquid crystal and the dielectric anisotropy Δε of the liquid crystal. According to FIG. 11, if the product Δε·V (V) is 16 or larger, the time τon required to turn on a barrier electrode becomes 15 milliseconds or less, while if the product Δε·V (V) is 22 or larger, the time τon required to turn on a barrier electrode becomes 10 milliseconds or less.

In the three-dimensional display device that uses the parallax barrier scheme using the eye tracking, characteristics of a three-dimensional image need to be evaluated with an oblique view, as well as a front view. In the parallax barrier scheme, crosstalk significantly affects the quality of an image. Crosstalk is substantially equal to the reciprocal of contrast of the TN liquid crystal. This is due to the fact that the crosstalk is determined by a ratio of luminescence when a black color is displayed and luminescence when a white color is displayed.

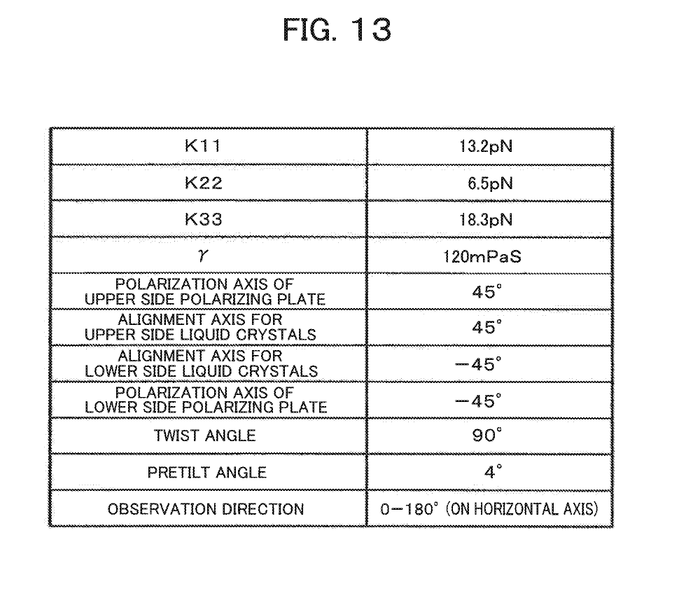

FIG. 12 is a graph showing relationships between Δε·V (V) and front contrast and oblique contrast. In FIG. 12, the abscissa represents Δε·V (V), the left ordinate represents the front contrast, and the right ordinate represents the oblique contrast obtained in a direction forming an angle of 30 degrees with respect to a normal direction of a screen. The graph shown in FIG. 12 is obtained by simulation, while parameters used in the simulation are illustrated as a table in FIG. 13.

K11, K22, and K33 illustrated in FIG. 13 are described above using Equation (1). Directions in which the contrast is observed are in a range of 0 degrees to 180 degrees, while directions of 0 degrees and 180 degrees are a horizontal direction with respect to the screen. Specifically, a position located in the direction that forms the angle of 30 degrees with respect to the normal direction is a position located in a direction forming the angle of 30 degrees with respect to a normal direction of a horizontal axis.

As illustrated in FIG. 12, the front contrast is improved as Δε·V (V) increases. On the other hand, the oblique contrast, which is obtained when the screen is viewed in the oblique direction forming the angle of 30 degrees with respect to the normal direction, is reduced as Δε·V (V) increases. To obtain a sufficient three-dimensional image when the screen is viewed in the oblique direction forming the angle of 30 degrees with respect to the normal direction of the screen, crosstalk is preferably 5% or less, more preferably 3% or less. Since the contrast may be considered as the reciprocal of crosstalk, the contrast is preferably 20 or larger, more preferably 33 or larger.

To satisfy this, Δε·V≦40, preferably, Δε·V≦27. In FIG. 12, if Δε·V is 27, the front contrast is 210 and the oblique contrast obtained in the direction forming the angle of 30 degrees is 32.

According to the invention, a response speed of the liquid crystal parallax barrier panel can be high in the parallax barrier scheme using the eye tracking, and a favorable three-dimensional image can be obtained without flicker and the like. In addition, a three-dimensional image with small crosstalk and excellent contrast can be obtained.

What is claimed is:

1. A three-dimensional display device comprising:
a display panel; and
a liquid crystal parallax barrier panel arranged on the display panel, the liquid crystal parallax barrier panel changing position of its barriers in accordance with a change in positions of viewer's eyes, wherein:
the display panel includes pixels arranged at first pitches in a first direction, the pixels each having a first sub-pixel, a second sub-pixel, and a third sub-pixel which are arranged in the first direction;
the liquid crystal parallax barrier panel includes a barrier substrate, a common substrate, and liquid crystal held between the barrier substrate and the common substrate;
on the barrier substrate, the barriers extend in a second direction perpendicular to the first direction and are arranged at second pitches in the first direction;
the barriers of the liquid crystal parallax barrier panel include barrier electrodes extending in the second direction and arranged in the first direction at third pitches;
the barriers are formed by applying a barrier signal to the barrier electrodes; and
where τon represents a time required to form barriers on the barrier electrodes after a voltage is applied to the barrier electrodes and τoff represents a time required to cancel the barriers after the voltage is removed from the barrier electrodes, a value of (τoff−τon) is 15 milliseconds or less.

2. The three-dimensional display device according to claim 1, wherein the value of (τoff−τon) is 10 milliseconds or less.

3. A three-dimensional display device comprising:
a display panel; and
a liquid crystal parallax barrier panel arranged on the display panel, the liquid crystal parallax barrier panel changing position of its barriers in accordance with a change in positions of viewer's eyes, wherein:
the display panel includes pixels arranged at first pitches in a first direction, the pixels each having a first sub-pixel, a second sub-pixel, and a third sub-pixel which are arranged in the first direction;
the liquid crystal parallax barrier panel includes a barrier substrate, a common substrate, and liquid crystal held between the barrier substrate and the common substrate;
on the barrier substrate, the barriers extend in a second direction perpendicular to the first direction and are arranged at second pitches in the first direction;
the barriers of the liquid crystal parallax barrier panel include barrier electrodes extending in the second direction and arranged in the first direction at third pitches; and
the liquid crystal parallax barrier panel satisfies a relationship of (γ≦(0.015π²K)/d²), where γ is a viscosity coefficient of liquid crystal and is expressed in a unit of Pascal×seconds, 0.015 is expressed in second, K is the average of an elastic constant K11 for splay deformation, an elastic constant K22 for twist, and an elastic constant K33 for bending or is (K11+K22+K33)/3 and expressed in Newton, and d is the thickness of a liquid crystal layer and expressed in meter.

4. The three-dimensional display device according to claim 3, wherein the liquid crystal parallax barrier panel satisfies a relationship of γ≦(0.01π²K)/d², where 0.01 is expressed in second.

5. The three-dimensional display device according to claim 3, wherein where a refractive index anisotropy of the parallax barriers is Δn, 400 nm≦Δn·d≦560 nm is satisfied.

6. A three-dimensional display device comprising:
a display panel; and
a liquid crystal parallax barrier panel arranged on the display panel, the liquid crystal parallax barrier panel changing position of its barriers in accordance with a change in positions of viewer's eyes, wherein:
the display panel includes pixels arranged at first pitches in a first direction, the pixels each having a first sub-pixel, a second sub-pixel, and a third sub-pixel which are arranged in the first direction;
the liquid crystal parallax barrier panel includes a barrier substrate, a common substrate, and liquid crystal held between the barrier substrate and the common substrate;
on the barrier substrate, the barriers extend in a second direction perpendicular to the first direction and are arranged at second pitches in the first direction;
the barriers of the liquid crystal parallax barrier panel include barrier electrodes extending in the second direction and arranged in the first direction at third pitches;
the barriers are formed by applying a barrier signal to the barrier electrodes; and
where a dielectric anisotropy of the liquid crystal is Δε and a voltage applied to the barrier electrodes is V, 16≦Δε·V≦40 is satisfied.

7. The three-dimensional display device according to claim 6, wherein 22≦Δε·V 27 is satisfied.

8. A three-dimensional display device comprising:
a display panel; and
a liquid crystal parallax barrier panel arranged on the display panel, the liquid crystal parallax barrier panel changing position of its barriers in accordance with a change in positions of viewer's eyes, wherein:
the display panel includes pixels arranged at first pitches in a first direction, the pixels each having a first sub-pixel, a second sub-pixel, and a third sub-pixel which are arranged in the first direction;
the liquid crystal parallax barrier panel includes a barrier substrate, a common substrate, and liquid crystal held between the barrier substrate and the common substrate;
on the barrier substrate, the barriers extend in a second direction perpendicular to the first direction and are arranged at second pitches in the first direction;
the barriers of the liquid crystal parallax barrier panel include
first barrier electrodes extending in the second direction and arranged in the first direction at third pitches, and
second barrier electrodes extending in the second direction and arranged in the first direction at the third pitches under the first barrier electrodes through an insulating layer so that the second barrier electrodes fill gaps between the first barrier electrodes;
the barriers are formed by applying a barrier signal to the first barrier electrodes or the second barrier electrodes; and
where τon represents a time required to form barriers on the barrier electrodes after a voltage is applied to the barrier electrodes and τoff represents a time required to cancel the barriers after the voltage is removed from the barrier electrodes, a value of (τoff−τon) is 15 milliseconds or less.

9. The three-dimensional display device according to claim 8, wherein the value of (τoff−τon) is 10 milliseconds or less.

10. A three-dimensional display device comprising:
a display panel; and
a liquid crystal parallax barrier panel arranged on the display panel, the liquid crystal parallax barrier panel changing position of its barriers in accordance with a change in positions of viewer's eyes, wherein:
the display panel includes pixels arranged at first pitches in a first direction, the pixels each having a first sub-pixel, a second sub-pixel, and a third sub-pixel which are arranged in the first direction;
the liquid crystal parallax barrier panel includes a barrier substrate, a common substrate, and liquid crystal held between the barrier substrate and the common substrate;
on the barrier substrate, the barriers extend in a second direction perpendicular to the first direction and are arranged at second pitches in the first direction;
the barriers of the liquid crystal parallax barrier panel include
first barrier electrodes extending in the second direction and arranged in the first direction at third pitches, and
second barrier electrodes extending in the second direction and arranged in the first direction at the third pitches under the first barrier electrodes through an insulating layer so that the second barrier electrodes fill gaps between the first barrier electrodes;
the barriers are formed by applying a barrier signal to the first barrier electrodes or the second barrier electrodes; and
the liquid crystal parallax barrier panel satisfies a relationship of γ≦(0.015π²K)/d², where γ is a viscosity coefficient of liquid crystal and is expressed in a unit of Pascal×seconds, 0.015 is expressed in second, K is the average of an elastic constant K11 for splay deformation, an elastic constant K22 for twist, and an elastic constant K33 for bending or is (K11+K22+K33)/3 and expressed in Newton, and d is the thickness of a liquid crystal layer and expressed in meter.

11. The three-dimensional display device according to claim 10, wherein the liquid crystal parallax barrier panel satisfies a relationship of γ≦(0.01π²K)/d², where 0.01 is expressed in second.

12. The three-dimensional display device according to claim 10, wherein where a refractive index anisotropy of the parallax barriers is Δn, 400 nm≦Δn·d≦560 nm is satisfied.

13. A three-dimensional display device comprising:
a display panel; and
a liquid crystal parallax barrier panel arranged on the display panel, the liquid crystal parallax barrier panel changing position of its barriers in accordance with a change in positions of viewer's eyes, wherein:
the display panel includes pixels arranged at first pitches in a first direction, the pixels each having a first sub-pixel, a second sub-pixel, and a third sub-pixel which are arranged in the first direction;
the liquid crystal parallax barrier panel includes a barrier substrate, a common substrate, and liquid crystal held between the barrier substrate and the common substrate;
on the barrier substrate, the barriers extend in a second direction perpendicular to the first direction and are arranged at second pitches in the first direction;
the barriers of the liquid crystal parallax barrier panel include
first barrier electrodes extending in the second direction and arranged in the first direction at third pitches, and
second barrier electrodes extending in the second direction and arranged in the first direction at the third pitches under the first barrier electrodes through an insulating layer so that the second barrier electrodes fill gaps between the first barrier electrodes;
the barriers are formed by applying a barrier signal to the first barrier electrodes or the second barrier electrodes; and
where a dielectric anisotropy of the liquid crystal is Δε and a voltage applied to the barrier electrodes is V, 16≦Δε·V≦40 is satisfied.

14. The three-dimensional display device according to claim 13, wherein 22≦Δε·V≦27 is satisfied.

15. The three-dimensional display device according to claim 1, wherein the liquid crystal display panel is of an IPS type.
